(19) United States
(12) Patent Application Publication
(10) Pub. No.: US 2012/0295136 A1
(43) Pub. Date: Nov. 22, 2012

(54) BATTERY PACK

(75) Inventors: Gueng Hyun NAM, Gwangju (KR); Hyoung Wook PARK, Gwamgju (KR); Min Ho JANG, Gwangju (KR); Dae Ung KIM, Gwangju (KR)

(73) Assignee: GLOBAL BATTERY CO., LTD., SEOUL (KR)

(21) Appl. No.: 13/193,903

(22) Filed: Jul. 29, 2011

(30) Foreign Application Priority Data
May 20, 2011 (KR) 10-2011-0047612

(51) Int. Cl. H01M 10/50; H01M 2/00; H01M 10/48; H01M 2/30; H01M 2/02

(52) U.S. Cl. 429/7; 429/120

(57) ABSTRACT

A battery pack, including a casing receiving a battery module, the battery module comprising a plurality of batteries, a first cooling unit installed in a surface of the casing and introducing a coolant into the casing; and a second cooling unit installed in an opposite surface of the casing and discharging the coolant introduced into the casing by the first cooling unit to the outside of the casing, thus causing the coolant to flow in the casing, wherein the batteries of the battery module are laminated in a predetermined direction inside the casing, with a space defined between the batteries so that the coolant can pass through the space between the batteries; and an end of the space of the battery module is open toward the first cooling unit and an opposite end of the space is open toward the second cooling unit.

### CROSS-REFERENCE TO RELATED APPLICATION

This application claims the benefit of Korean Patent Application No. 10-2011-0047612 filed on May 20, 2011, in the Korean Patent and Trademark Office, the disclosures of which are incorporated herein in their entirety by reference.

### BACKGROUND OF THE INVENTION

1. Field of the Invention

The present invention relates to a battery pack configured to cool batteries.

2. Description of the Related Art

In recent years, secondary batteries have attracted attention as power sources of electric vehicles (EV) and hybrid electric vehicles (HEV) that have been proposed as a solution to air pollution caused by conventional vehicles using fossil fuel, such as gasoline or diesel oil.

From the point of view of a battery's shape, there is a great demand for prismatic secondary batteries and pouch-type secondary batteries that are thin in dimension and can be effectively used in compact products, such as mobile phones.

In recent years, a pouch-type battery in which a battery assembly is housed in a pouch-type battery casing made of a laminated aluminum sheet has attracted attention due to low production cost, light weight and easy change in the shape thereof and, further, the demand for pouch-type batteries has increased.

To realize the output power capacity desired by a user, the pouch-type battery has been fabricated by integrating a plurality of batteries into a battery module.

In the related art, the battery module is fabricated by laminating a plurality of pouch-type batteries and is used in a predetermined place desired by the user.

However, the conventional battery module is problematic in that the surfaces of the batteries are in contact with each other so that heat may be condensed into the gaps between the batteries, thereby reducing heat dissipating efficiency of the battery module.

In an effort to solve the inferior heat dissipating structure of the battery module, a technique in which heat dissipating plates are arranged in the battery module in such a way that the heat dissipating plates protrude outside the laminated structure at locations between the batteries, thereby dissipating the heat to the atmosphere has been proposed and used in the related art.

However, this technique requires an addition of elements and increases the volume, weight and production cost of products.

In the related art, another technique to solve the inferior heat dissipating structure of the conventional battery module has been proposed. In the technique, a battery module having laminated batteries is arranged upright in a hermetic casing, in which a coolant is forcibly introduced into the casing from the upper end of a side surface of the casing and, then, flows downwards from the top to the bottom prior to being discharged from the lower end of an opposite side surface, thereby dissipating the heat to the atmosphere.

However, this technique is problematic in that because the battery module is arranged upright in the casing and the coolant flows downwards in the casing from the top to the bottom, the technique cannot realize a smooth flow of the coolant.

Further, to introduce and discharge the coolant into and from the gaps between the batteries of the battery module, it is necessary to use a high capacity cooling blower so as to induce a forcible flow of the coolant in the battery module.

However, the high capacity cooling blower must consume an excessive amount of electricity and increases the production cost of the cooling battery pack.

### SUMMARY OF THE INVENTION

Accordingly, the present invention has been made keeping in mind the above problems occurring in the related art, and the present invention is intended to propose a battery pack, which is provided with a coolant flowing unit for flowing a coolant into a casing receiving a battery module therein, defines a space between the batteries of the battery module and forms a coolant flowing line in the space defined between the batteries, thereby efficiently cooling the batteries by dissipating the heat produced in the operation of the batteries.

In order to achieve the above or another object, according to one aspect of the present invention, there is provided a battery pack configured to cool batteries, the battery pack including a casing; a first cooling unit; and a second cooling unit.

According to an aspect of the present invention, a battery pack, includes: a casing; a first cooling unit installed in a first surface of the casing and introducing a coolant into the casing; a second cooling unit installed in a second surface opposite to the first surface of the casing and discharging the coolant introduced into the casing by the first cooling unit to the outside of the casing to cause the coolant to flow in the casing; and a battery module positioned in the casing, the battery module including a plurality of batteries laminated in a predetermined direction inside the casing, with a space defined between the batteries so that the coolant can pass through the space between the batteries, wherein an end of the space of the battery module is open toward the first cooling unit and an opposite end of the space is open toward the second cooling unit.

According to an aspect of the present invention, the battery pack further includes: input/output terminal units connected to a positive pole and a negative pole of the battery module and leading input/output electricity of the battery module relative to the casing, wherein the input/output terminal units are exposed outside the casing, and are collectively arranged on one side of the casing or are separately arranged on opposite sides of the casing.

According to an aspect of the present invention, the battery pack further includes: a protection circuit module unit for monitoring an operational state of the battery pack and controlling the operation of the battery pack.

According to an aspect of the present invention, the first cooling unit and the second cooling unit are motor fans.

According to an aspect of the present invention, at least one of the first cooling unit and the second cooling unit is further provided with a filter unit for preventing impurities from being received into the battery pack.

According to an aspect of the present invention, the battery pack further includes: a monitor unit for displaying operation states monitored by the protection circuit module unit.

According to an aspect of the present invention, a battery pack module system, includes: a plurality of battery packs, each battery pack including: a casing; a first cooling unit installed in a first surface of the casing and introducing a coolant into the casing; a second cooling unit installed in a second surface opposite to the first surface of the casing and discharging the coolant introduced into the casing by the first cooling unit to the outside of the casing to cause the coolant to flow in the casing; and a battery module positioned in the casing, the battery module including a plurality of batteries laminated in a predetermined direction inside the casing, with a space defined between the batteries so that the coolant can pass through the space between the batteries, wherein an end of the space of the battery module is open toward the first cooling unit and an opposite end of the space is open toward the second cooling unit, wherein a first input/output terminal unit is installed on at least one of the casings of the plurality of battery packs electrically connected to each other and a second input/output terminal unit is installed on at least one of the casings of the plurality of battery packs.

According to an aspect of the present invention, the battery pack module system further includes: a battery management system unit monitoring and controlling operation of a system monitoring unit, a system control setting unit, a system sensor unit, a system display unit, a system alarm unit, a system cooling control unit, the battery packs and the PCM units of the battery packs, the battery management system unit transmitting the monitored operational information to the system monitoring unit; a system monitoring unit receiving the monitored operation information through a remote communication method; a system control setting unit connected to the battery management system unit, the system control setting unit monitoring and setting an operational environment of the battery pack module system, wherein, in response to preset operational environment data output from the system control setting unit, the battery management system unit compares the operational information to the preset operational environmental data and controlling the operation; a system sensor unit sensing levels and input/output states of voltages, currents and electricity of the battery packs and monitoring over-discharge, overcharge and overheat of the battery packs; a system display unit displaying the information about the operation, monitored by the battery management system unit and the system sensor unit; a system alarm unit generating an alarm signal and informing an operator of an abnormal operation of the battery pack module system when the battery management system unit determines that the battery pack module system is being abnormally operated; and a system cooling control controlling the operation of the respective cooling units of the plurality of battery packs.

According to an aspect of the present invention, the protection circuit module unit receives a control signal for controlling the battery packs from the battery management system unit in response to the information about the operation of the battery packs applied to the system sensor unit, and controls the operation of the batteries in such a way that the protection circuit module unit stops supply of input/output power of the batteries or the operation of the batteries in response to the control signal output from the battery management system unit.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view of a battery pack according to a first embodiment of the present invention;

FIG. 2 is an opened-up perspective view of the battery pack according to the first embodiment of the present invention showing the interior;

FIG. 3 is a front opened-up view of the battery pack according to the first embodiment of the present invention showing the interior;

FIG. 4 is a block diagram showing the construction of a PCM unit according to the first embodiment of the present invention;

FIG. 5 is a perspective view of a battery pack according to a second embodiment of the present invention; and

FIG. 6 is a block diagram showing the construction of a battery pack module system according to a third embodiment of the present invention.

### DETAILED DESCRIPTION OF THE INVENTION

The present invention will now be described more fully hereinafter with reference to the accompanying drawings, in which exemplary embodiments of the invention are shown. The present invention may, however, be embodied in many different forms and should not be construed as being limited to the embodiments set forth herein. In other words, the present invention may be changed or modified using equivalents or substitutes without departing from the scope and spirit of the invention. In the following description, it is to be noted that, when the functions of conventional elements and the detailed description of elements related with the present invention may make the gist of the present invention unclear, a detailed description of those elements will be omitted.

It will be understood that although the terms “first,” “second,” etc. may be used herein to describe various elements, these elements should not be limited by these terms. These terms are only used to distinguish one element from another element.

Further, it is noted that the terminology used herein is for the purpose of describing particular embodiments only and is not intended to limit the invention. As used herein, the singular forms are intended to include the plural forms as well, unless the context clearly indicates otherwise. It will be further understood that the terms “comprises” and/or “comprising,” or “includes” and/or “including,” when used in this specification, specify the presence of stated features, integers, steps, operations, elements, components and/or groups thereof, but do not preclude the presence or addition of one or more other features, integers, steps, operations, elements, components and/or groups thereof.

Reference will now be made in greater detail to a battery pack according to an embodiment of the present invention, an example of which is illustrated in the accompanying drawings. Wherever possible, the same reference numerals will be used throughout the drawings and the description to refer to the same or like parts and the repeated description of the same or like parts will be omitted.

For ease of description, the surface in which a monitor unit 5 is installed will be referred to as the front surface of a casing, the surface opposite to the front surface will be referred to as the rear surface and the surfaces on the left-hand side, right-hand side, upper side and lower side of the drawings will be referred to as the left surface, right surface, upper surface and lower surface of the casing, respectively.

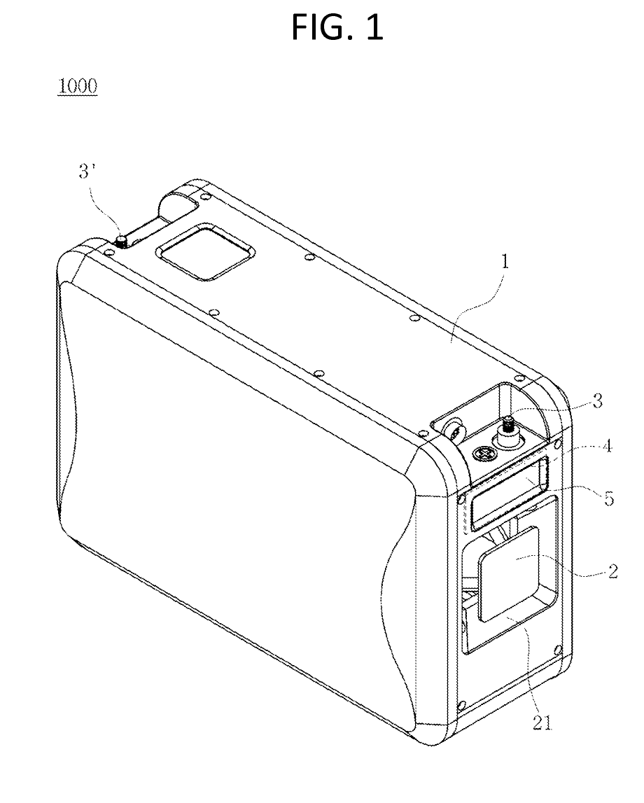

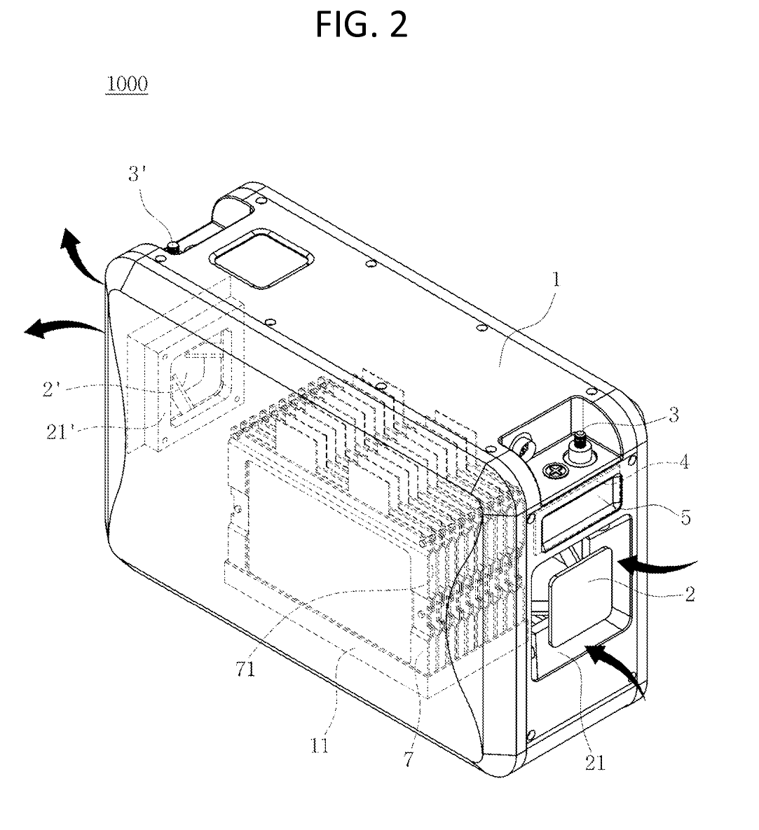

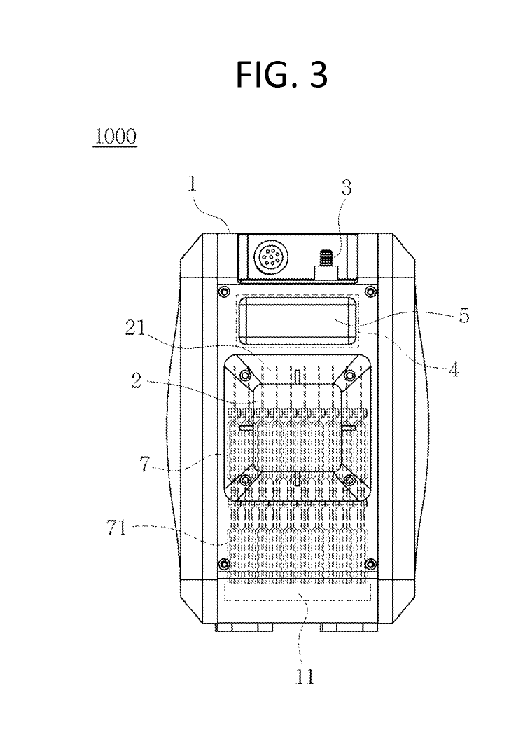

FIG. 1 is a perspective view of a battery pack according to the first embodiment of the present invention. FIG. 2 is an opened-up perspective view of the battery pack according to the first embodiment of the present invention showing the interior. FIG. 3 is a front opened-up view of the battery pack according to the first embodiment of the present invention showing the interior.

As shown in FIG. 1 through FIG. 3, the battery pack according to the first embodiment of the present invention includes a casing 1, a first cooling unit 2, a second cooling unit 2′, a first input/output terminal unit 3, a second input/output terminal unit 3′, a PCM (protection circuit module) unit 4 and a monitor unit 5.

In the casing 1, a battery module 7 is firmly mounted in such a way that the battery module 7 can be isolated from the outside of the casing.

The casing 1 may include a battery seat 11 for seating the battery module 7 having a plurality of laminated batteries.

The material of the casing 1 may be selected from a variety of materials, such as steel, aluminum and reinforced plastic, according to the usage and using environments of a battery pack 1000.

The first cooling unit 2 and the second cooling unit 2′ may be placed in the front and rear surfaces of the casing 1, respectively.

The first cooling unit 2 placed in the front surface introduces the coolant into the casing 1 so that the coolant can flow in the casing 1. The second cooling unit 2′ placed in the rear surface discharges the coolant to the outside of the casing 1.

The first cooling unit 2 and the second cooling unit 2′ may be further provided with a first filter unit 21 and a second filter unit 21′, respectively, thereby preventing impurities from being introduced into the battery pack.

The first cooling unit 2 and the second cooling unit 2′ may use electric motor fans.

The battery module 7 may be fabricated by laminating a plurality of batteries in a predetermined direction, with a space 71 defined between the batteries as shown in FIG. 2. In the casing 1, the batteries may be arranged to be parallel to each other in a direction from the left surface to the right surface.

Hereinbelow, the operational structure of the battery pack according to the first embodiment of the present invention will be described.

Further, the direction from the front surface having the first cooling unit 2 to the rear surface having the second cooling unit 2′ crosses the direction from the left surface to the right surface, in which the plurality of batteries of the battery module 7 are sequentially laminated.

In other words, the batteries may be arranged in such a way that the front open end of the space 71 defined between the batteries is oriented toward the first cooling unit 2 and the rear open end of the space 71 is oriented toward the second cooling unit 2′.

The first cooling unit 2 installed in the front surface introduces a coolant into the casing 1 and the second cooling unit 2′ installed in the rear surface discharges the coolant so that the coolant inside the casing flows from the first cooling unit 2 to the second cooling unit 2′ through a coolant flowing line, as shown by the arrows in FIG. 2.

Here, the direction of the space 71, which has been defined between the batteries when the plurality of batteries are laminated to form the battery module 7, is parallel to the direction of the coolant flowing line from the front surface having the first cooling unit 2 to the rear surface having the second cooling unit 2′.

Therefore, when the coolant passes through the space 71 defined between the batteries, the coolant dissipates the heat produced in the operation of the batteries to the outside of the casing 1.

In the conventional battery pack, the direction of the laminated batteries of the battery module 7 is parallel to the coolant flowing direction from the upper end of a surface of the casing to the lower end of an opposite surface of the casing so that the coolant flowing line extends from the upper end to the lower end of the casing after sequentially passing through the upper end and the lower end of the battery module. Therefore, the conventional battery pack may not realize desired fluidity of the coolant due to a quick change in the flowing direction of the coolant and thereby requires high capacity blowers for efficiently introducing and discharging the coolant into and from the casing.

However, in the present invention, the direction of the space 71 in the battery module 7 is parallel to the direction of the coolant flowing line extending from the first cooling unit 2 to the second cooling unit 2′, so that the direction of the coolant flowing line is not changed unlike the conventional battery pack, thereby realizing a desired cooling effect using the coolant without requiring a high capacity blower.

Further, the direction in which the batteries are laminated to form the battery module 7 is not limited to the direction from the left surface to the right surface of the casing 1 shown in the drawings, but, for example, the batteries may be laminated in a direction from the lower surface to the upper surface of the casing 1. Further, in the present invention, even when the batteries are laminated in an inclined arrangement to form a predetermined inclination capable of matching a specified structure of an electric circuit, the coolant flowing line formed by the cooling units passes through the space 71 defined between the batteries.

The first input/output terminal unit 3 and the second input/output terminal unit 3′ are respectively connected to the positive pole and to the negative pole of the battery module 7 installed in the casing 1, thereby leading electric power to the inside and outside of the casing 1.

As shown in FIG. 1, the first input/output terminal unit 3 and the second input/output terminal unit 3′ may be installed in such a way that the first input/output terminal unit 3 is placed in the front surface of the casing 1 and the second input/output terminal unit 3′ is placed in the rear surface of the casing 2.

Further, the locations and shapes of the input/output terminal units 3 and 3′ may be easily changed by those skilled in the art in such a way that the input/output terminal units 3 and 3′ are collectively arranged on one side of the casing in accordance with the usage and installation environment of the terminal units 3 and 3′.

The PCM unit 4 can monitor the operation of the battery pack 1000 and can control the operation of the battery pack 1000.

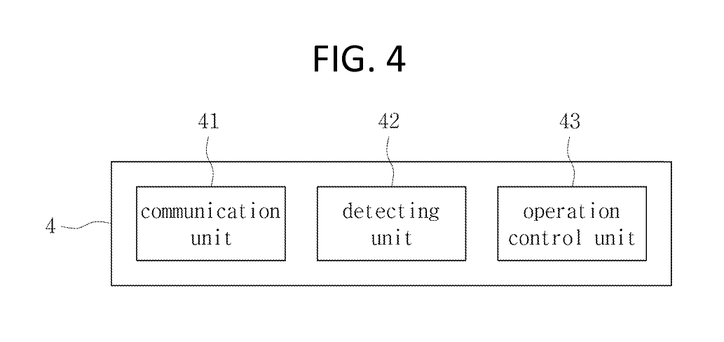

As shown in FIG. 4, the PCM unit 4 may include a communication unit 41, a detecting unit 42 and an operation control unit 43.

The detecting unit 42 is connected to the batteries of the battery module 7 installed in the casing 1 and monitors the operational states of the battery pack.

The operational states may include the temperature inside the casing 1, respective temperatures of the batteries, information about the respective power of the batteries, abnormal operation of the batteries, etc.

In response to abnormal operation of the batteries, the operation control unit 43 may stop the supply of input/output power of the batteries or may stop the operation of the batteries.

The communication unit 41 transmits the information about the operational state of the battery pack 1000 monitored by the detecting unit 42 to a monitor unit 5.

In an embodiment of the present invention, when the battery pack 1000 is provided with a system control unit for monitoring and controlling the operation of the battery pack 1000, the communication unit 41 may transmit the information, which represents the monitored operational state of the battery pack or represents the state of controlling the operation of the battery pack 1000 output from the system control unit, to the operation control unit 43.

The monitor unit 5 may display thereon the operational state monitored by the PCM unit 4.

The monitor unit 5 may display the information about the temperature inside the casing 1, respective temperatures of the batteries, respective powers of the batteries and the operational states of the batteries on a screen so that an operator can view the information, which is being displayed on the screen, at the outside of the casing without disassembling the casing.

In an embodiment of the present invention, the monitor unit 5 may use an LCD panel.

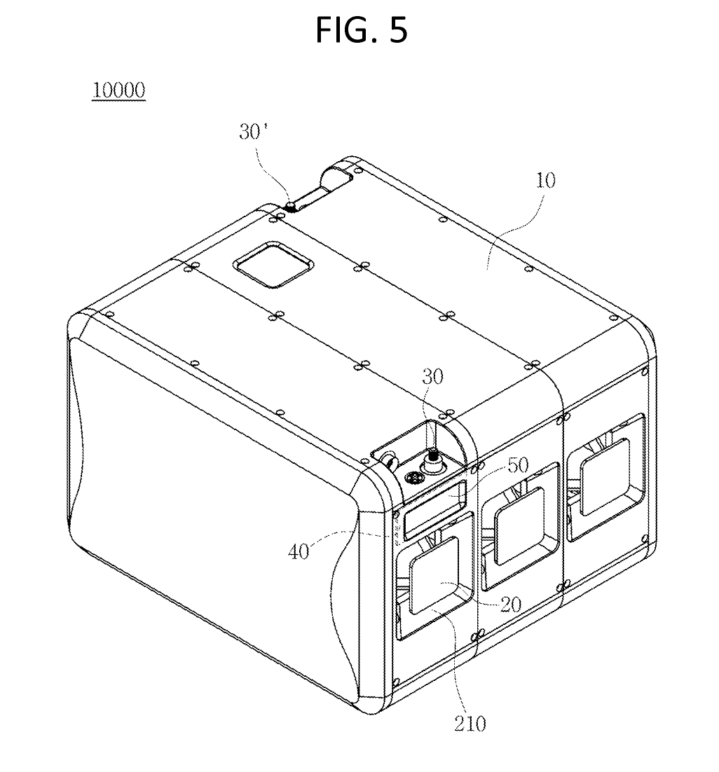

FIG. 5 is a perspective view of a battery pack module according to a second embodiment of the present invention.

The battery pack module 10000 may be fabricated by assembling a desired number of battery packs.

In the same manner as that described for the first embodiment shown in FIG. 1 through FIG. 4, the plurality of battery packs constituting the battery pack module according to the second embodiment have respective cooling units in the front and rear surfaces of respective battery pack casings, with one battery module installed in each battery pack casing 10.

The battery module of each battery pack includes a plurality of batteries laminated in such a way that a space is defined between the batteries. Further, a coolant flowing line is formed by the cooling units, which are installed in the front and rear surfaces of each battery pack casing, in such a way that the coolant flowing line can pass through the space defined between the batteries of the battery module, thereby efficiently cooling the battery module.

Further, in the battery pack module 10000, to realize easy fabrication of an electric circuit for supplying electricity, a first input/output terminal unit 30 may be installed on a predetermined location in the front surface of the casing 10 and a second input/output terminal unit 30′ may be installed on a predetermined location in the rear surface of the casing 10.

Further, the locations and shapes of input/output terminal units 30 and 30′ may be easily changed by those skilled in the art in such a way that the input/output terminal units 30 and 30′ are collectively arranged on one side of the casing in accordance with the usage and installation environment of the terminal units 30 and 30′.

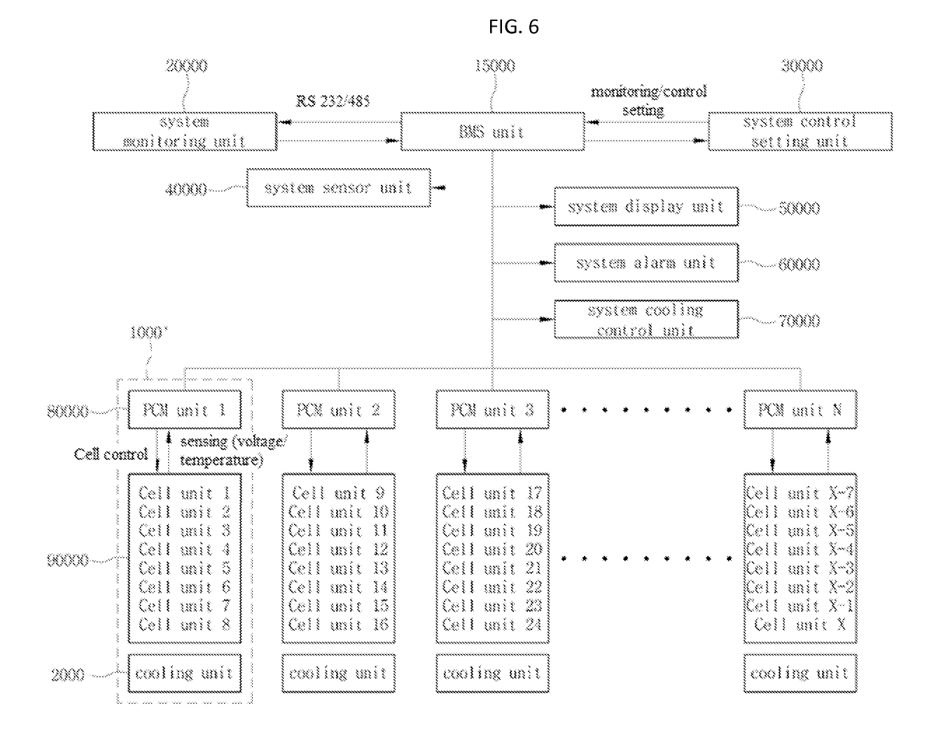

FIG. 6 is a block diagram illustrating the construction of a battery pack module system according to a third embodiment of the present invention.

The battery pack module system (hereinbelow, referred to simply as “the module system”) may includes a BMS (battery management system) unit 15000, a system monitoring unit 20000, a system control setting unit 30000, a system sensor unit 40000, a system display unit 50000, a system alarm unit 60000, a system cooling control unit 70000 and a battery pack 1000′.

The battery pack 1000′ may include a cooling unit 2000, a PCM unit 80000 and a cell unit 90000.

In this embodiment, the module system may include a plurality of battery packs 1000′ so as to realize the output power capacity desired by a user.

Further, the cell unit 90000 of the battery pack 1000′ may include a plurality of cells (cell 1 through cell X) so as to realize the desired output power capacity according to the usage of the module system desired by a user.

The BMS unit 15000 can monitor the operational states and control the operation of the system monitoring unit 20000, the system control setting unit 30000, the system sensor unit 40000, the system display unit 50000, the system alarm unit 60000, the system cooling control unit 70000, the battery packs 1000′ and the respective PCM units 80000 of the battery packs 1000′ (hereinbelow, referred to simply as ‘the respective elements’).

The system monitoring unit 20000 may receive the information about the operation monitored by the BMS unit 15000 through a remote communication method and may display the information by a display unit.

The BMS unit 15000 can transmit the monitored operational information to the system monitoring unit 20000 using RS-232 or RS-485 communication protocol.

The system control setting unit 30000 is connected to the BMS unit 15000 and monitors and sets the operational environment of the module system. In response to preset operational environment data output from the system control setting unit 30000, the BMS unit 15000 compares the information about the operation of the respective elements to the preset operational environment of the module system and controls the operation of the respective elements connected thereto.

The system sensor unit 40000 can sense the levels and input/output states of voltages, currents and electricity of the battery packs 1000′ connected to the module system and can monitor the over-discharge, overcharge and overheat of the battery packs 1000′.

The system display unit 50000 can display the operational data monitored by both the BMS unit 15000 and the system sensor unit 40000.

When the operation of the module system deviates from the operational states preset in the BMS unit 15000 by the system control setting unit 30000 and the BMS unit 15000 determines that the module system is being abnormally operated, the system alarm unit 60000 generates an alarm signal and informs an operator of the abnormal operation of the module system.

The system cooling control unit 70000 can control the operation of the respective cooling units 2000 of the plurality of battery packs 1000′.

The system cooling control unit 70000 can control the temperatures of the cooling units 2000 of the battery packs 1000′ according to overheated states of the battery packs 1000′ sensed by the system sensor unit 40000, thereby controlling the temperatures of the battery packs 1000′.

The PCM unit 80000 can monitor the operational states of the battery packs 1000′ and can control the operation of the battery packs 1000.

The PCM unit 80000 is connected to the plurality of batteries of each cell unit 90000 and can monitor the operational states of the respective batteries.

The operational states may include the temperatures inside the respective battery packs 1000′, the temperatures of the respective batteries, information about the respective power of the batteries, abnormal operations of the batteries, etc.

The PCM unit 80000 can transmit the information about the battery packs 1000′ and the information about the respective batteries of each cell unit 90000 to the system sensor unit 40000.

The PCM unit 80000 receives a control signal for controlling the battery packs 1000′ from the BMS unit 15000 in response to the information about the operation of the battery packs 1000′ applied to the system sensor unit 40000, so that the PCM unit 80000 can control the operation of the batteries in such a way that the PCM unit 80000 may stop the supply of input/output power of the batteries or may stop the operation of the batteries in response to the control signal output from the BMS unit 15000.

Although embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A battery pack, comprising:
a casing;
a first cooling unit installed in a first surface of the casing and introducing a coolant into the casing;
a second cooling unit installed in a second surface opposite to the first surface of the casing and discharging the coolant introduced into the casing by the first cooling unit to the outside of the casing to cause the coolant to flow in the casing; and
a battery module positioned in the casing, the battery module comprising a plurality of batteries laminated in a predetermined direction inside the casing, with a space defined between the batteries so that the coolant can pass through the space between the batteries, wherein an end of the space of the battery module is open toward the first cooling unit and an opposite end of the space is open toward the second cooling unit.

2. The battery pack as set forth in claim 1, further comprising:
input/output terminal units connected to a positive pole and a negative pole of the battery module and leading input/output electricity of the battery module relative to the casing, wherein the input/output terminal units are exposed outside the casing, and are collectively arranged on one side of the casing or are separately arranged on opposite sides of the casing.

3. The battery pack as set forth in claim 1, further comprising:
a protection circuit module unit for monitoring an operational state of the battery pack and controlling the operation of the battery pack.

4. The battery pack as set forth in claim 1, wherein the first cooling unit and the second cooling unit are motor fans.

5. The battery pack as set forth in claim 1, wherein at least one of the first cooling unit and the second cooling unit is further provided with a filter unit for preventing impurities from being received into the battery pack.

6. The battery pack as set forth in claim 3, further comprising:
a monitor unit for displaying operation states monitored by the protection circuit module unit.

7. A battery pack module system, comprising:
a plurality of battery packs, each battery pack comprising:
a casing;
a first cooling unit installed in a first surface of the casing and introducing a coolant into the casing;
a second cooling unit installed in a second surface opposite to the first surface of the casing and discharging the coolant introduced into the casing by the first cooling unit to the outside of the casing to cause the coolant to flow in the casing; and
a battery module positioned in the casing, the battery module comprising a plurality of batteries laminated in a predetermined direction inside the casing, with a space defined between the batteries so that the coolant can pass through the space between the batteries, wherein an end of the space of the battery module is open toward the first cooling unit and an opposite end of the space is open toward the second cooling unit;
wherein a first input/output terminal unit is installed on at least one of the casings of the plurality of battery packs electrically connected to each other and a second input/output terminal unit is installed on at least one of the casings of the plurality of battery packs.

8. The battery pack module system as set forth in claim 7, further comprising:
a protection circuit module unit for monitoring an operational state of the battery packs and controlling the operation of the battery packs.

9. The battery pack module system as set forth in claim 7, wherein the first cooling unit and the second cooling unit are motor fans.

10. The battery pack module system as set forth in claim 7, wherein at least one of the first cooling unit and the second cooling unit is further provided with a filter unit for preventing impurities from being received into the battery pack.

11. The battery pack module system as set forth in claim 8, further comprising:
a monitor unit for displaying operation states monitored by the protection circuit module unit.

12. The battery pack module system as set forth in claim 8, further comprising:
a battery management system unit monitoring and controlling operation of a system monitoring unit, a system control setting unit, a system sensor unit, a system display unit, a system alarm unit, a system cooling control unit, the battery packs and the PCM units of the battery packs, the battery management system unit transmitting the monitored operational information to the system monitoring unit;
a system monitoring unit receiving the monitored operation information through a remote communication method;
a system control setting unit connected to the battery management system unit, the system control setting unit monitoring and setting an operational environment of the battery pack module system, wherein, in response to preset operational environment data output from the system control setting unit, the battery management system unit compares the operational information to the preset operational environmental data and controlling the operation;
a system sensor unit sensing levels and input/output states of voltages, currents and electricity of the battery packs and monitoring over-discharge, overcharge and overheat of the battery packs;
a system display unit displaying the information about the operation, monitored by the battery management system unit and the system sensor unit;
a system alarm unit generating an alarm signal and informing an operator of an abnormal operation of the battery pack module system when the battery management system unit determines that the battery pack module system is being abnormally operated; and
a system cooling control controlling the operation of the respective cooling units of the plurality of battery packs.

13. The battery pack module system as set forth in claim 12, wherein the protection circuit module unit receives a control signal for controlling the battery packs from the battery management system unit in response to the information about the operation of the battery packs applied to the system sensor unit, and controls the operation of the batteries in such a way that the protection circuit module unit stops supply of input/output power of the batteries or the operation of the batteries in response to the control signal output from the battery management system unit.
